(19) United States
(12) Patent Application Publication
(10) Pub. No.: US 2007/0181185 A1
(43) Pub. Date: Aug. 9, 2007

(54) APPARATUS AND METHOD FOR PREPARING A MULTIPLE PHASE CONFECTIONERY PRODUCT

(76) Inventor: James C. Clark, St. Louis, MO (US)

Correspondence Address: BELL, BOYD & LLOYD LLP, P.O. Box 1135, CHICAGO, IL, 60690, US

(21) Appl. No.: 11/564,512

(22) Filed: Nov. 29, 2006

Related U.S. Application Data
(60) Provisional application No. 60/765,865, filed on Feb. 7, 2006.

(51) Int. Cl. F16K 51/00

(52) U.S. Cl. 137/245

(57) ABSTRACT

The present disclosure provides an apparatus for producing a multiple phase confectionery article. The apparatus may include a housing with a chamber, the housing having a first inlet and a first outlet, and a second inlet and a second outlet. A rotary valve may be disposed within the chamber, the rotary valve having a first bore and a second bore. The first bore may provide fluid communication between the first inlet and the first outlet when the rotary valve is in a first position, and the second bore may provide fluid communication between the second inlet and the second outlet when the rotary valve is in a second position. The apparatus may include a dispensing member in fluid communication with each outlet to dispense a continuous confectionery article having sequential amounts of a first confectionery material and a second confectionery material. Each confectionery material may have a different visual and/or organoleptic property.

### PRIORITY CLAIM

This application claims the benefit of U.S. Provisional Patent Application Serial No. 60/765,865 filed on Feb. 7, 2006, the entire content of which is incorporated herein.

### BACKGROUND

Multiple component confectionery products are known in the art. Such products are typically prepared by coextruding two or more fluid confectionery materials to form a laminated multiple component confectionery product. Problems exist, however, in the production of a multiple component confectionery product having different confectionery materials sequentially disposed in the product. This is due in part to the unpredictable flow properties of many confectionery materials when placed in a fluid state. The complications associated with unpredictable confectionery flow properties are further amplified with the discontinuous dispensing that occurs during sequential formation of a continuous multiple component confectionery product. A need therefore exists for an apparatus for sequentially dispensing confectionery material regardless of the confectionery flow characteristics in order to form a continuous multiple component confectionery product.

### SUMMARY

The present disclosure provides an apparatus for producing a multiple phase confectionery article. The apparatus may include a housing with a chamber, the housing having a first inlet and a first outlet, and a second inlet and a second outlet. A rotary valve may be disposed within the chamber, the rotary valve having a first bore and a second bore. The first bore may provide fluid communication between the first inlet and the first outlet when the rotary valve is in a first position, and the second bore may provide fluid communication between the second inlet and the second outlet when the rotary valve is in a second position.

In an embodiment, the first and second inlets may be in fluid communication with respective first and second sources of fluid confectionery material. In a further embodiment, the first and second bores may be disposed in a vertically stacked arrangement in the rotary valve. In a further embodiment, the first bore and the second bore each may extend diametrically through the rotary valve. In yet a further embodiment, the bores may be in a vertically stacked arrangement and may be skewed with respect to each other.

In an embodiment, the apparatus may include a dispensing member in fluid communication with the first outlet and the second outlet. An amount of the first fluid confectionery may be dispensed from the dispensing member when the rotary valve is in the first position. Similarly, an amount of second fluid confectionery may be dispensed from the dispensing member when the rotary valve is positioned in the second dispensing position. In an embodiment, the dispensed first and second fluid confectionery materials may form a continuous confectionery product.

In an embodiment, the confectionery product may have a sequential order of first and second confectionery materials. In yet a further embodiment, the confectionery product may have a repeating sequence of first and second confectionery materials. In an embodiment, the continuous confectionery product may have a delineation line between the first confectionery material and the second confectionery material. In an further embodiment, the continuous confectionery product may include a blend area between the first confectionery material and the second confectionery material.

In an embodiment, the apparatus may include a conveyor proximate to the dispensing member for receiving the dispensed fluid confectionery. The rotary valve may be placed in operative communication with the conveyor by way of a controller. In an embodiment, movement of the conveyor may be coordinated with the rotation of the rotary valve by the controller.

In yet another embodiment, a method for depositing a multiple phase confectionery article is provided. The method may include providing a depositing apparatus having a housing and a rotary valve disposed within the housing. The housing may have a first inlet and outlet arrangement and a second inlet and outlet arrangement. Each inlet may be in fluid communication with a respective fluid confectionery material. The outlets may be in fluid communication with a dispensing member. The method may further include moving the rotary valve to a first position to dispense a first fluid confectionery from the dispensing member, further moving the rotary valve to a second position to dispense a second fluid confectionery from the dispensing member, and forming a continuous confectionery product having an amount of the first confectionery material and an amount of the second confectionery material.

In an embodiment, the method may include rapidly further moving the rotary valve to the second position to form a delineation line between the first and the second confectionery material in the confectionery product.

In an embodiment, the method may include slowly further moving the rotary valve to the second position to form a blend area between the first and second confectionery materials in the confectionery product.

In an embodiment, the method may include receiving the confectionery product on a conveyor. In yet a further embodiment, the moving of the rotary valve may be coordinated with the receiving of the confectionery product on the conveyor.

In a further embodiment, a method for depositing a multiple phase confectionery article is provided. The method includes providing a depositing apparatus having a housing and a rotary valve disposed within the housing. The housing may have a plurality of inlet and outlet arrangements. Each inlet may be in fluid communication with a respective source of fluid confectionery material. Each outlet may be in fluid communication with a dispensing member. The method further entails sequentially moving the rotary valve to dispense an amount of each of the plurality of confectionery materials from each respective inlet and outlet arrangement through the dispensing member, and forming a continuous confectionery product having a sequence or a sequential order of each confectionery material.

In an embodiment, the method may include repeating the sequentially moving to form a continuous confectionery product having a repeating sequence of each confectionery material. In an embodiment, the sequentially moving may include moving the rotary valve between a first position, a second position, a third position, and a fourth position in a predetermined order to produce a continuous confectionery product with respective first, second, third, and fourth confectionery materials in a repeating sequence.

In an embodiment, a confectionery article is provided that includes a confectionery product having a width and a thickness, the confectionery product having at least two confectionery materials. Each confectionery material may extend across the width and through the thickness of the confectionery product, with each confectionery material having a visually different property. In an embodiment, the confectionery material may be chewing gum, bubble gum, nougat, pliable confectionery material, taffy, soft candy, chewy candy, caramel, and combinations thereof. The difference in visual property may be based on color, surface texture, confectionery composition and combinations thereof. In an embodiment, the confectionery article may contain from about 3 to about 10 confectionery materials. In a further embodiment, each visually different confectionery material further includes a respective different organoleptic property. The difference in organoleptic property may be based on flavor, aroma, softness, mouthfeel, and combinations thereof.

In an embodiment, each confectionery material is visible from the top, bottom, and sides of the confectionery article.

In an embodiment, the visually different confectionery materials form a visual unit. The confectionery product may include a repeating sequence from about two visual units to about 50 visual units.

In an embodiment, the confectionery materials may be coextruded confectionery materials or sequentially dispensed confectionery materials.

In an embodiment, the confectionery article may have a thickness from about 0.03 inches to about 2.0 inches and a length from about 1 foot to about 15 feet. In a further embodiment, each confectionery material may have a length from about 1 inch to about one foot and a width from about 0.25 inches to about 12 inches.

In an embodiment, the confectionery article may include a delineation line between each confectionery material. In a further embodiment, the confectionery article may include a blend area between each confectionery material. In yet a further embodiment, the confectionery article may include a combination of delineation lines and blend areas between the confectionery materials.

Additional features and advantages are described herein, and will be apparent from, the following Detailed Description and the Figures.

### BRIEF DESCRIPTION OF THE FIGURES

FIG. 1 is a perspective view of a confectionery dispensing apparatus in accordance with the present disclosure.

FIG. 2 is an exploded perspective view of the apparatus of FIG. 1.

FIG. 3A is an enlarged fragmentary perspective view of a portion of the apparatus of FIG. 1.

FIG. 3B is an exploded sectional view taken along line 3B-3B of FIG. 3A.

FIG. 3C is a front perspective view of a rotary valve in accordance with an embodiment of the present disclosure.

FIG. 3D is a sectional view of the rotary valve taken along line 3D-3D of FIG. 3C.

FIG. 3E is front perspective view of a rotary valve in accordance with an embodiment of the present disclosure.

FIG. 3F is a sectional view of the rotary valve taken along line 3F-3F of FIG. 3E.

FIG. 4A is a partially cut-away plan view of the apparatus of FIG. 1.

FIG. 4B is a sectional view of the apparatus taken along line 4B-4B of FIG. 4A.

FIG. 5A is a partially cut-away plan view of the apparatus of FIG. 1.

FIG. 5B is a sectional view of the apparatus taken along line 5B-5B of FIG. 5A.

FIG. 6A is a perspective view of a confectionery dispensing system in accordance with an embodiment of the present disclosure.

FIG. 6B is an enlarged plan view of area 6B of FIG. 6A.

FIG. 7A is a perspective view of a confectionery dispensing system accordance with an embodiment of the present disclosure.

FIG. 7B is an enlarged plan view of area 7B of FIG. 7A.

### DETAILED DESCRIPTION

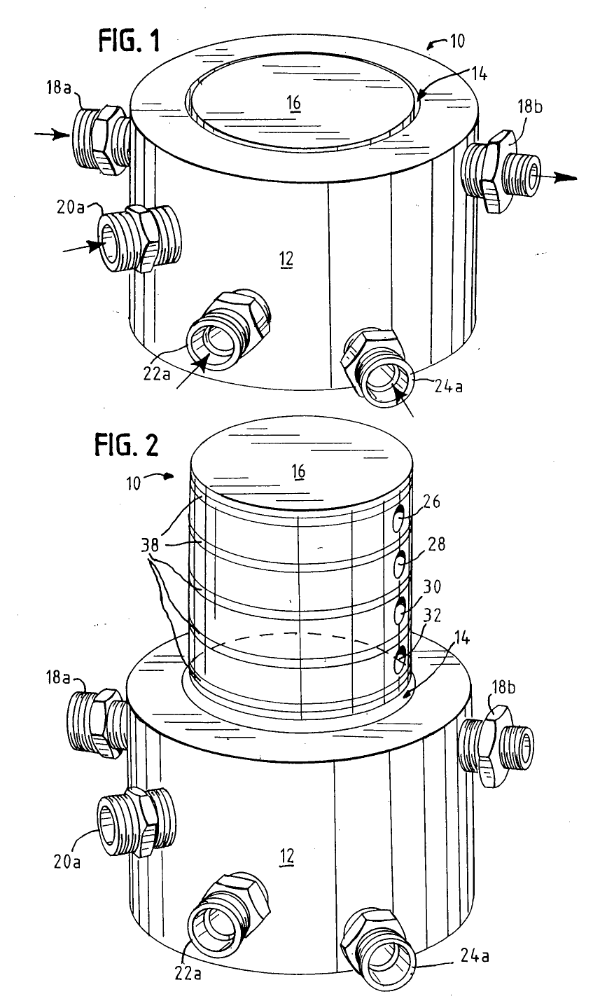

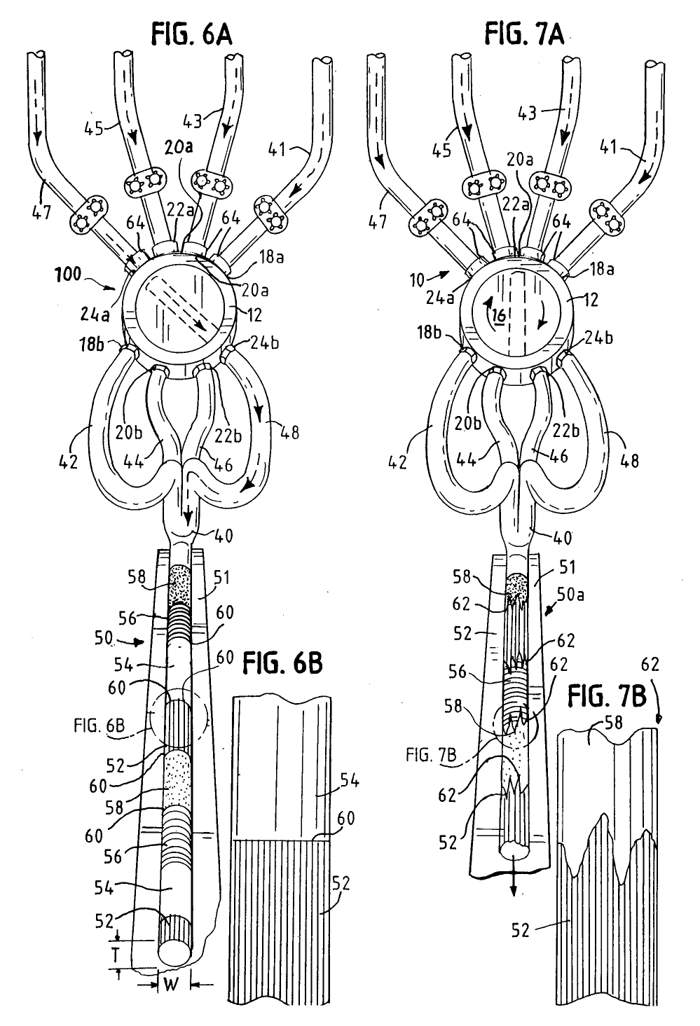

Referring to the Figures generally, where like reference numerals denote like structure and elements, and in particular, to FIGS. 1-7A, a multiple port dispensing apparatus 10 for producing a multiple phase confectionery product is shown. In FIG. 1, apparatus 10 includes a housing 12, chamber 14, rotary valve 16, and inlet/outlet arrangements such as first inlet 18a and corresponding first outlet 18b, second inlet 20a and corresponding second outlet 20b (FIGS. 6A, 7A), third inlet 22a and corresponding third outlet 22b (FIGS. 6A, 7A) and fourth inlet 24a and corresponding fourth outlet 24b (FIGS. 6A, 7A). Housing 12 and rotary valve 16 may be made of any suitable material as commonly known in the art. Non-limiting examples of suitable materials include metal or a low-friction polymeric material. In an embodiment, housing 12 and rotary valve 16 may each be made of stainless steel. In a further embodiment, chamber 14 may be coated with a non-stick or low friction polymeric material such as TEFLON®, for example. Similarly, the outer surface of rotary valve 16 may be coated with a non-stick or low friction material such as TEFLON®.

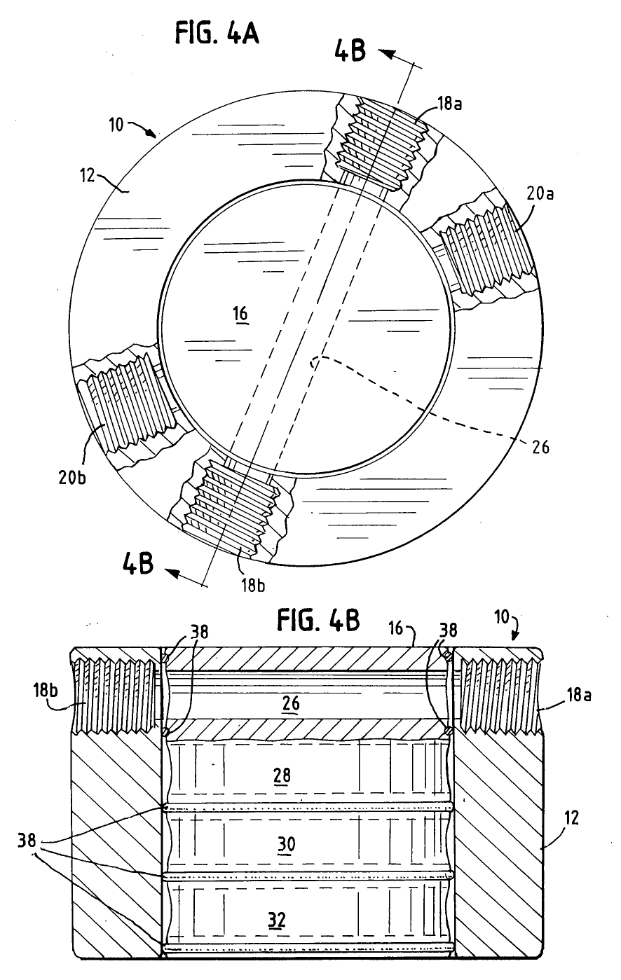

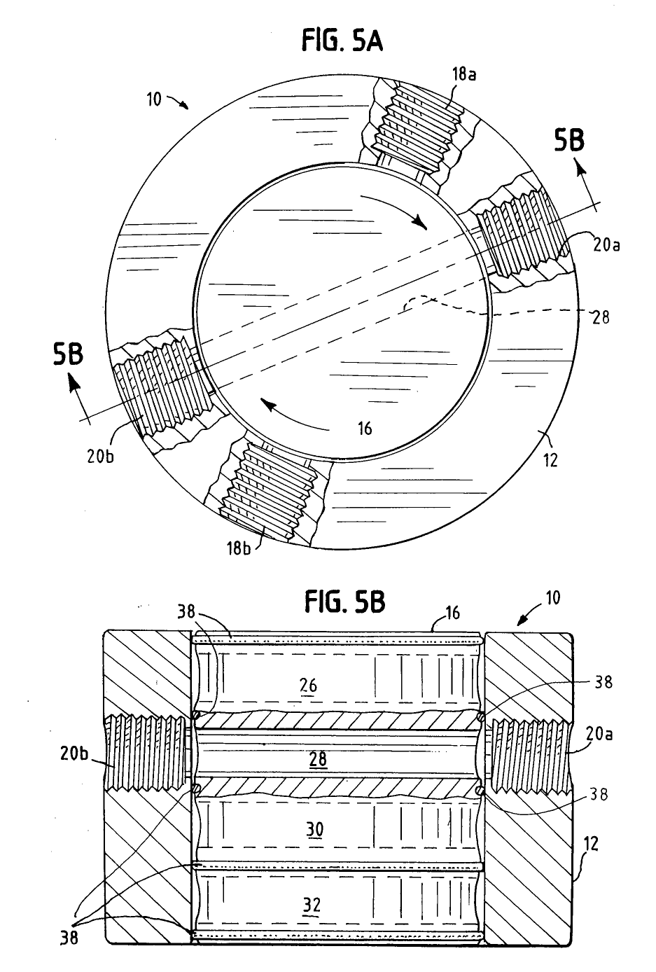

Each individual inlet and outlet extends through housing 12 to provide fluid communication between chamber 14 and the housing exterior. For example, inlet/outlet 18a, 18b and inlet/outlet 20a, 20b each extend through housing 12 as shown in FIGS. 4A and 5A. In an embodiment, each inlet/outlet pair may be diametrically disposed about housing 12. This provides a direct line-of-sight or a straight line between each inlet and respective outlet as shown by inlet/outlet pair 18a, 18b in FIG. 4B, for example. Although FIG. 1 shows four inlet/outlet pairs, it is understood that apparatus 10 may have from 2 to 3, 4, 5, 6, 10, or more inlet/outlet pairs.

Each inlet may be in fluid communication with a corresponding source of confectionery material. For example, a first source of confectionery material may be in fluid communication with inlet 18a and a second source of confectionery material may be placed in fluid communication with inlet 20a and so on. The confectionery material in each source may be the same or different. Each confectionery source may be any container or reservoir suitably adapted to contain or otherwise hold a quantity of flowable confectionery material as is commonly known in the art, such as a hopper or an extruder, for example. The confectionery material may be any hard candy, soft candy, chewing gum, or other confectionery substance, or compound that has a fluid phase or may take a flowable form. In other words, the confectionery material may be melted, form a syrup, or be dissolved in a liquid to become flowable as is commonly known in the art. The skilled artisan will appreciate that the moisture content (and concomitant viscosity) of the confectionery material may vary greatly. The moisture content of the flowable phase of the confectionery substrate may typically be in the range of about 2% to about 20% by weight of the confectionery material. The flowable confectionery material may be subsequently cooled or solidified at room temperature to form a solid or semi-solid confectionery. Nonlimiting examples of suitable confectionery materials that are flowable or may placed into a flowable state include syrups, liquids or solids for making hard candies, soft candies, lollipops, fondants, toffees, jellies, chewing gums, chocolates, gelatins and nougats. The confectionery material may include sugar or may be sugar-free. Coloring may be added to the confectionery substrate as desired. The confectionery material may also include a pharmaceutical product or a medicament.

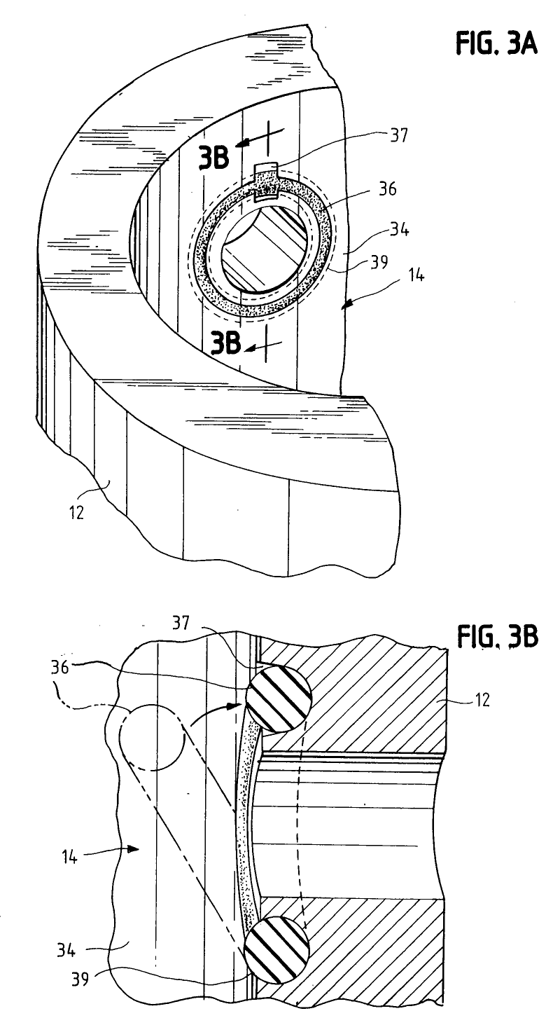

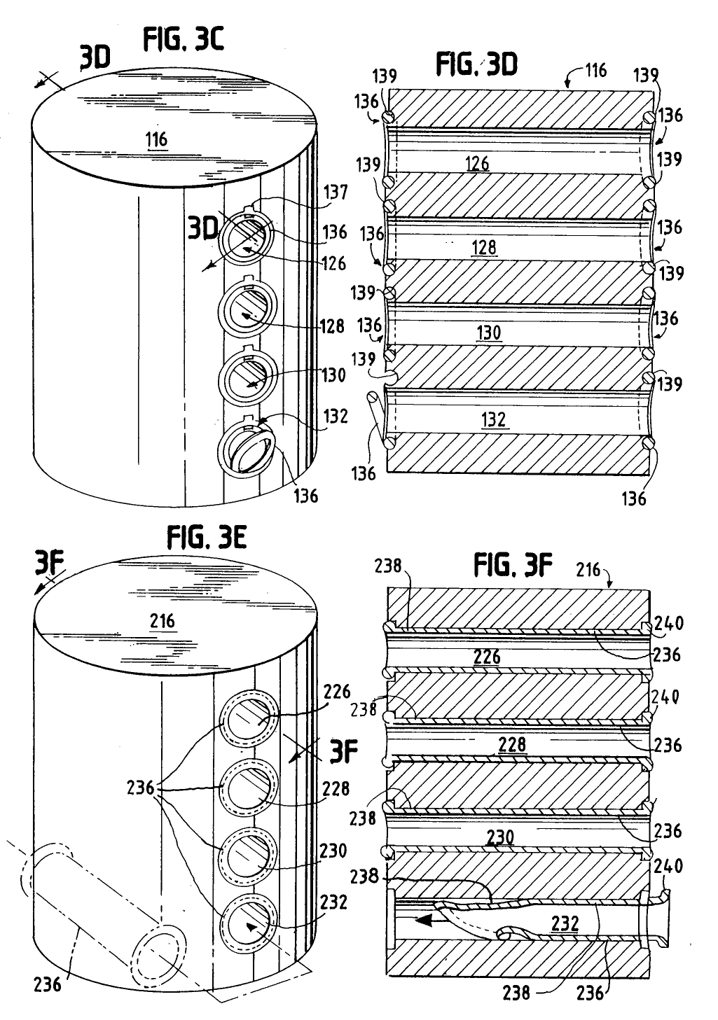

Inner surface 34 (FIG. 3A) of housing 12 defines chamber 14. In an embodiment, inner surface 34 may have a substantially circular circumference. Chamber 14 may be adapted to receive rotary valve 16 which may extend through the entire vertical extent of housing 12 thereby creating a substantially annular housing. Alternatively, housing 12 may include a base portion (not shown) upon which rotary valve 16 may rest when disposed in chamber 14. In an embodiment, the inner surface of housing 12 forms a cylindrical, or substantially cylindrical shape permitting rotary valve 16 to rotate freely within chamber 14.

Rotary valve 16 may be disposed within chamber 14 as shown in FIG. 1. Alternatively, apparatus 10 may be configured so that rotary valve 16 may be substantially horizontally disposed. In an embodiment, rotary valve 16 may be vertically disposed in housing 12. Rotary valve 16 may include first bore 26, second bore 28, third bore 30 and fourth bore 32. In an embodiment, the number of bores correspond to the number inlet/outlet pairs in housing 12. In a further embodiment, the bores may be disposed in a vertically stacked arrangement. In a vertically stacked arrangement, the bores are positioned one on top of each other with the orifices of each bore aligning to form a vertical line as shown in FIG. 2. Alternatively, the bores may be disposed one on top of each other with the orifices not in alignment, the bores in a skewed relation with respect to each other. Each bore may extend through the body of rotary valve 16. In an embodiment, each bore may extend diametrically through the rotary valve 16 as shown in FIGS. 4A and 5A for example. In a further embodiment, the outer diameter of rotary valve 16 may be substantially equal to or slightly less than the inner diameter of chamber 14. This may provide a friction fit between rotary valve 16 and the inner surface of housing 12. Rotary valve 16 may be operatively connected to a drive device as commonly known in the art. Nonlimiting examples of suitable drive devices include hydraulic drive devices and pneumatic drive devices. Alternatively, rotary valve 16 may be equipped with a handle or the like and be rotated manually.

In an embodiment, gasket 36 may be provided to surround the orifice of inlet 18a on inner wall 34 of housing 12 as shown in FIG. 3A. Gasket 36 may be placed into pinch groove 39 as shown in FIGS. 3A and 3B. The width of pinch groove 39 may be slightly less than the width of gasket 36. Gasket 36 may be compressed and placed into pinch groove 39. Once in pinch groove 39, gasket 36 expands to provide a firm friction fit in pinch groove 39. Gasket 36 may extend slightly away from surface 34. In an embodiment, pinch groove 39 may be configured with a tool entry 37 permitting easy installation and removal of gasket 36 to/from pinch groove 39. Housing 12 may be further configured with a seat circumferentially disposed about each orifice to maintain gasket 36 in position around the orifice. Gasket 36 thereby remains in place despite frictional engagement with rotary valve 16 upon rotation thereof. Gasket 36 may be made of any compressive and resilient material such as natural or synthetic rubber, or similar elastomer as is commonly known in the art. Gasket 36 may advantageously provide additional sealing around first inlet 18a thereby preventing escape or seepage of fluid confectionary materials. The remaining inlets and outlets of housing 12 may be configured with a gasket in a similar manner.

In a further embodiment, a gasket 136 may surround the orifice of each bore 126, 128, 130, and 132 of rotary valve 116 in a similar manner as shown in FIGS. 3C and 3D. Gasket 136 may compressively fit into pinch groove 139, gasket 136 expansively filling pinch groove 139 to provide a firm friction fit between gasket 136 and pinch groove 139, the smaller width of pinch groove 139 restraining gasket 136 therein. Gasket 136 may have one or more tool entries 137. FIG. 3D shows one gasket removed to expose pinch groove 139. One, some, or all bore orifices of rotary valve 116 may be configured with gasket 136 as desired. Gasket 136 advantageously provides additional sealing around each bore thereby leakage of fluid confectionary material into chamber 14. In yet a further embodiment, apparatus 10 may include a gasket surrounding some or all of the inlet and outlet orifices, and/or some or all of the bore orifices.

In a further embodiment, rotary valve 216 may include tubular gasket 236 disposed in one, some, or all bores 226, 228, 230, and 232 as shown in FIGS. 3E and 3F. Tubular gasket 236 includes a length portion 238 and a ring portion 240. Length portion 238 may be substantially coextensive with the length of the bore. Ring portion 240 extends outwardly from the external circumferential surface of rotary valve 236 and may rest in a seat on the outer surface of valve 216. Tubular gasket 236 may be made of any natural or synthetic rubber or elastomer as commonly known in the art. In an embodiment, length portion 238 of tubular gasket 236 may contact confectionery material as the confectionery material passes through rotary valve 216. Correspondingly tubular gasket 236 may be made of a material that is compatible with the fluid confectionery material(s) that pass through rotary valve 216. Tubular gasket 236 may be compressed to fit into a respective bore with the length thereof subsequently stretched or otherwise expanded to place ring portions 240 in contact with the outer surface of rotary valve 236 as shown in FIG. 3F. The stretched orientation of the length of tubular gasket 236 advantageously maintains the gasket in place, particularly when ring portions 240 frictionally engage inner surface 34 of housing 12.

In an embodiment, rotary valve 16 may include one or more gaskets 38 circumferentially disposed about the exterior surface of the body of rotary valve 16 as shown in FIG. 2. In an embodiment, the outer surface of rotary valve 16 may be configured with circumferential grooves to hold the gasket. Gaskets 38 advantageously provide a leak-proof friction-fit between rotary valve 16 and inner wall 34. Gaskets 38 further advantageously prevent seepage of fluid confectionery material between bores and/or inlet/outlets in chamber 18 and/or between housing 12 and rotary valve 16.

In an embodiment, rotary valve 16 may be rotated or otherwise moved to a first position as illustrated in FIGS. 4A and 4B. In this first position, bore 26 provides fluid communication between first inlet 18a and first outlet 18b. This permits confectionery material to be delivered from the confectionery source, through inlet 18a, through rotary valve 16 and out of outlet 18a. It is understood that apparatus 10 may be in operative communication with a suitable fluid drive mechanism (i.e., screw extruder or pump, or the like) to deliver confectionery material from the source, through housing 12 and rotary valve 16 and 10 and out through outlet 18b.

In an embodiment, rotary valve 16 may be rotated to a second position as illustrated in FIGS. 5A and 5B. In the second position, bore 28 provides fluid communication between inlet 20a and outlet 20b. This permits confectionery material to be dispensed from a second source of fluid confectionery material, through inlet 20a, through rotary valve 16, and out of outlet 20b. It is understood that rotary valve 16 may be moved to a third position to establish fluid communication between a third inlet/outlet pair with a third bore (inlet/outlet 22a, 22b via bore 30 for example, moved to a fourth position to establish fluid communication between a fourth inlet/outlet pair with a fourth bore (inlet/out 24a, 24b via bore 32, for example), and so on.

In a further embodiment, the bores and inlet/outlet pairs may be arranged such that fluid communication between a single inlet/outlet pair may exist at any given time. In other words, when first fluid confectionery material is flowing through inlet/outlet 18a, 18b by way of bore 26, apparatus 10 may be configured to prevent fluid communication between any other inlet/outlet. This is apparent in FIG. 4B where bore 26 provides fluid communication between inlet 18a and outlet 18b. However, FIG. 4B indicates that no fluid communication exists between any other inlet/outlet pair. Similarly, when rotary valve 16 is moved to the second position, bore 28 provides fluid communication with inlet 20a and outlet 20b as shown in FIG. 5B. No fluid communication exists between any other inlet/outlet pair in FIG. 5B.

In an embodiment, apparatus 10 may be a part of system 100 for producing a continuous multiple phase confectionery article as shown in FIGS. 6A and 7A. In an embodiment, apparatus 10 may include dispensing member 40 in fluid communication with one or more of the outlets as shown in FIGS. 6A and 7A. FIG. 6A shows tubing 42, 44, 46, 48 placing respective outlets 18b, 20b, 22b, and 24b in fluid communication with dispensing member 40. It is understood that tubing 41, 43, 45, 47, may place respective inlets 18a, 20a, 22a, and 24a in fluid communication with respective sources of confectionery material. Dispensing member 40 may be used to dispense a continuous rope or strand of confectionery material. In an embodiment, dispensing member 40 may include separate individual channels to receive each fluid confectionery material from each respective outlet. Alternatively, dispensing member 40 may have a single channel in fluid communication with each tubing 42, 44, 46, 48.

In an embodiment, apparatus 10 may be a part of system 100 for producing a multiple phase confectionery product as shown in FIGS. 6A and 7A. In a further embodiment, apparatus 10 may include dispensing member 40 which may be used to dispense or otherwise form a continuous strand of confectionery product 50. In an embodiment, strand 50 may be a continuous strand of a multiple phase confectionery product having portions of first confectionery material 52, second confectionery material 54, third confectionery material 56, and fourth confectionery material 58, and any combination thereof as shown in FIGS. 6A and 6B. It is understood that the confectionery product may include less than four confectionery materials or more than four confectionery materials as desired. Confectionery materials 52, 54, 56, and 58 may be the same or different and may be stored in separate confectionery sources as previously discussed. The dispensed amounts of each confectionery material may be the same or different. In an embodiment, each confectionery material may have a separate or distinct organoleptic and/or visual property. For example, each confectionery material may have a different color (red 52, blue 54, green 56, yellow 58, for example), a different flavor (cherry, blueberry, lime, lemon, for example), a different texture, a different aroma, a different mouthfeel, either alone or in any combination thereof. Indeed, each confectionery material may further be a distinct or separate confectionery material (i.e., soft candy as the first confectionery material, chewing gum for the second confectionery material, taffy for the third confectionery material, and hard candy as the fourth confectionery material). Provision of a multiple phase confectionery product with different organoleptic and/or visual properties advantageously increases enjoyment of the product and heightens consumer appeal.

In an embodiment, confectionery product 50 may be a continuous strand with each confectionery material 52, 54, 56, 58 integral to each adjacent confectionery material. FIG. 6A shows rotary valve 16 in a fourth position and dispensing a fourth confectionery 58 material through inlet/outlet 24a, 24b by way of bore 32 (shown in phantom), out of dispensing member 40, and onto conveyor 51. Conveyor 51 is located proximate to dispensing member 40 and is adapted to receive the continuous strand of confectionery product 50. It is understood that apparatus 10 previously dispensed first, second, and third confectionery materials 52, 54, and 56 by being moved to the first, second, and third dispensing positions respectively. As shown in FIG. 6A, rotary valve 16 may be moved or otherwise rotated sequentially between first, second, third and fourth positions as is evident by the sequential order of confectionery materials 52, 54, 56, and 58 in confectionery product 50. In an embodiment, rotary valve 16 may be moved back to the first position after dispensing an amount of fourth confectionery material 58. Alternatively, rotary valve 16 may be moved in any order between the different dispensing positions as desired.

In an embodiment, confectionery strand 50 may include an amount of at least two confectionery materials having a visually different property, or confectionery materials 52, 54, 56, and 58, each having a visually different property. As each confectionery material is sequentially dispensed, each confectionery material may extend across the entire width and the entire thickness of confectionery strand 50 as shown in FIGS. 6B and 7B. In a further embodiment, each visually different confectionery material may further include a different organoleptic property such as flavor, aroma, mouthfeel, texture, softness, and combinations thereof.

In an embodiment, confectionery product 50 may include delineation lines 60 between each confectionery material as shown in FIGS. 6A and 6B. Clear, crisp, sharp, distinct, well-defined lines of delineation between each confectionery material are advantageous as these lines exhibit to a consumer a detailed, clean, multiple phase confectionery product. Crisp delineation lines 60 further advantageously provide attraction to the product as the clearly defined multiple phases generate consumer excitement with the anticipation of a new sensory experience (taste, aroma, mouthfeel, for example) upon the crossing of each delineation line.

In an embodiment, delineation lines 60 may be obtained by manipulation of rotary valve 16. In particular, rapid movement or rotation of rotary valve 16 between different positions (i.e., between first position to second position, between second position to third position, between fourth position to first position, etc.) abruptly changes the flow between individual confectionery materials. This abrupt change or rapid movement yields a clean, distinct demarcation line between adjacent confectionery materials in confectionery product 50. A time lag may or may not exist between the rapid rotation of rotary valve 16 (the formation of the delineation line) and the appearance of the delineation line between adjacent confectionery materials upon deposit of confectionery material from dispensing member 40.

In an embodiment, system 100 may include a pressure sensing device 64 in operative communication with inlet 18a, 20a, 22a, and 24a as shown in FIGS. 6A and 7A. Pressure sensing device 64 may be configured to maintain a constant or substantially constant pressure of the confectionery material during periods of flow (i.e., fluid communication between an inlet/outlet pair) and non-flow (no fluid communication between an inlet/outlet pair). Pressure sensing device 64 advantageously maintains a consistent confectionery set pressure at each inlet so that when the rotary valve is moved to a dispensing position, confectionery flow begins immediately or substantially immediately at the desired flow rate. Provision of pressure sensing device 64 advantageously ensures clean cut-off and start-up of confectionery flow when the rotary valve is moved between dispensing positions. This contributes to the crisp demarcation of delineation lines 60 in confectionery strand 50. In an embodiment, pressure sensing device 64 maintains the inlet set pressure at about 50-300 psi or about 100-200 psi.

In an embodiment, confectionery product 50 dispensed from system 100 may have a width W and a thickness T as shown in FIG. 6A. Each confectionery material may extend across width W and through thickness T of the confectionery product 50. Although FIG. 6A shows confectionery product 50 with four different confectionery materials (52, 54, 56, 58), it is understood that confectionery product 50 may contain as few as two different confectionery materials to 3, 4, 5, 6, or 10 or more different confectionery materials. Each confectionery material may have a different visual property as previously discussed. In an embodiment, the visually different property of each confectionery material may be color, texture, confectionery composition and combinations thereof. In an embodiment, each visually different confectionery material may have a respective different organoleptic property. Nonlimiting examples of organoleptic properties that may differ between the confectionery materials include flavor, aroma, softness, mouthfeel, and combinations thereof.

In a further embodiment, rotation of rotary valve 16 between positions may be coordinated with movement of conveyor 51. This coordination between valve rotation and conveyor movement may be utilized to further enhance, demarcate, or clarify delineation lines 60. Rotary valve 16 may be placed in operative communication with conveyor 51 by way of a controller, which may be in operative communication with conveyor 51. The controller may be a programmable logic controller, or other device as commonly known in the art. The controller may then be used to direct valve rotation while simultaneously halting conveyor movement during valve rotation. For example, the controller may direct rotary valve 16 to rotate from one dispensing position to another dispensing position while simultaneously directing conveyor 51 to halt. Once confectionery material flow resumes (i.e., once fluid communication is established between an inlet/outlet arrangement), the controller may be used to direct the conveyor to resume movement. Thus, valve rotation may be essentially transparent to movement of confectionery strand 50 as confectionery flow occurs simultaneously with conveyor movement and confectionery flow halts with conveyor stoppage.

In certain products, delineation lines between the confectionery materials may not be desired. In an embodiment, apparatus 10 may be used to form a confectionery product with blend areas 62 between the individual confectionery materials as shown in FIGS. 7A and 7B. Blend areas 62 may exhibit a mix of adjacent or sequentially dispensed individual confectionery materials, and may be denoted by the commingling or intermingling of protrusions, streaks and/or striations of adjacent confectionery materials. Blend area 62 may be further denoted by designs, patterns, or streaks of adjacent confectionery materials in continuous confectionery product 50a. Blend area 62 may include the presence of two, three, four, five, or more confectionery materials.

In an embodiment, blend areas 62 may be formed by slowly moving rotary valve between dispensing positions. For example, blend area 62 between first confectionery material 52 and fourth confectionery material 58 (FIGS. 7A and 7B) may be formed by slowly moving rotary valve 16 between the first position and the fourth position. Slow movement between dispensing positions allows an amount of first confectionery 52 and fourth confectionery material 58 to be dispensed simultaneously or substantially simultaneously from dispensing member 40. This results in a blending or mixing of first confectionery material 52 and fourth confectionery material 58 as shown by blend area 62 in FIG. 7B.

In a further embodiment, rotary valve 16 may be configured so that the bores may be in a skewed relation (i.e., neither parallel nor intersecting) with respect to each other. This skewed bore (i.e., bore orifices do not align to make a straight line) orientation may also permit simultaneous or near simultaneous dispensing of two or more confectionery materials for the formation of blend areas 62.

In an embodiment, FIG. 7A further indicates non-sequential or otherwise random movement of rotary valve 16 between the dispensing positions. This is evident as continuous confectionery product 50a has first confectionery material 52 adjoining fourth confectionery material 58 which contacts third confectionery material 56 which is integral to first confectionery material 52 which joins fourth confectionery material 58 (exiting dispensing member 40). This order of confectionery materials in continuous product 50a indicates that rotary valve 16 was moved to dispensing positions in the following order: first position, fourth position, third position, first position, and fourth position. Indeed, in an embodiment, rotary valve 16 may avoid one or more dispensing positions (i.e., the second position avoided in FIG. 7A), thereby eliminating one or more confectionery materials in the strand of confectionery product. Thus, an advantage of the present apparatus is the versatility offered in the ability to dispense one, two, three, four, or more fluid confectionery materials using apparatus 10 with little or no set-up changes. Moreover, the dispensing of a given confectionery material may be avoided if a problem exists in the flow for that confectionery material line, for example.

In an embodiment, system 100 may be configured with redundant confectionery dispensing lines (of similar or different materials) to ensure continuous production and account for line start-up time and, line maintenance time. For example, first and second confectionery sources may hold the same confectionery material with rotary valve in the first position (line 1) or second position (line 2) dispensing this first confectionery material. The other lines may contain other confectionery materials. Line 1 may dispense the first material (from the first source) while line 2 is prepared, repaired, or maintained. Similarly, line 2 may dispense the first confectionery material (from the second source) while line 1 is prepared, repaired, or maintained. The inoperative line may be avoided by simply rotating rotary valve to other active dispensing lines. Apparatus 10 and/or system 100 may be advantageously used in a production environment to increase production times, reduce equipment downtime, and increase productivity.

In an embodiment, a method for depositing a multiple phase confectionery article is provided. The method may include moving rotary valve 16 to a first position to dispense a first fluid confectionery material (such as first confectionery material 52) from dispensing member 40. The method may further include further moving rotary valve 16 to a second position to dispense a second fluid confectionery (such as confectionery material 54) from dispensing member 40, and forming a continuous confectionery product having sequential amounts of the first and second confectionery material.

In an embodiment, the method may include sequentially moving the rotary valve to dispensing positions in order to form a confectionery product with a repeating order of sequentially arranged confectionery materials. For example, rotary valve 16 may be moved the into the following dispensing positions: first position, second position, third position, and fourth position. This order of movement may be exercised to produce confectionery product 50 having confectionery materials in the following order: 52, 54, 56, and 58 as shown in FIG. 6A. In an embodiment, this sequential order of confectionery dispensing may define a visual unit. For example, FIG. 6A depicts a four-material visual unit that includes first confectionery material 52, second confectionery material 54, third confectionery material 56, and fourth confectionery material 58. The sequential order may be repeated to form a confectionery product having a series of repeating visual units of confectionery material: [52, 54, 56, 58]-[52,54, 56, 58]-[52, 54, 56, 58]-etc. In an embodiment, the number of visual units may be from about two visual units to about 50 visual units. Rotary valve 16 may be rotated rapidly or slowly to form delineation lines or blend areas as desired.

In a further embodiment, the sequential movement of the rotary valve may be predetermined. For example, the rotary valve may be moved in the following predetermined sequence: first position, second position, third position. This sequence may then be repeated as necessary. Repetition of this predetermined sequential rotary valve movement may yield a confectionery product having repeating sequences of confectionery material in the following order: [52, 54, 56]-[52, 54, 56]-[52, 54, 56]-etc. Alternatively, rotary valve 16 may be rotated in a random manner to produce a confectionery product having a random order or no pre-determined order of individual confectionery materials.

The continuous confectionery product 50 produced by system 100 may be cut and packaged to form a confectionery article having any of the above-described characteristics. In an embodiment, the confectionery article may have a length from about one foot to about 15 feet, or about 6 feet to about 15 feet wherein the length of each confectionery material may be from about 1 inch to from about one inch to about one foot or from about 3 inches to about 9 inches. In a further embodiment, the confectionery article may have a thickness from about 0.03 inches to about 2.0 inches and a length from about 1 foot to about 15 feet. In a further embodiment, each confectionery material may have a width from about from about 0.25 inches to about 12 inches.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An apparatus for producing a multiple phase confectionery article comprising:
a housing having a chamber, the housing having a first inlet and a first outlet, and a second inlet and a second outlet;
a rotary valve disposed within the chamber, the rotary valve having a first bore and a second bore, each bore extending through the rotary valve; and
the first bore providing fluid communication between the first inlet and the first outlet when the rotary valve is in a first position, and the second bore providing fluid communication between the second inlet and the second outlet when the rotary valve is in a second position.

2. The apparatus of claim 1 further comprising a first fluid confectionery source in fluid communication with the first inlet and a second fluid confectionery source in fluid communication with the second inlet.

3. The apparatus of claim 1 further comprising a dispensing member in fluid communication with the first outlet and the second outlet.

4. The apparatus of claim 3 wherein a first fluid confectionery material is dispensed from the dispensing member when the rotary valve is in the first position and a second fluid confectionery material is dispensed from the dispensing member when the rotary valve is in the second position, the dispensed first and second fluid confectionery materials forming a continuous confectionery product.

5. The apparatus of claim 4 wherein the continuous confectionery product has a delineation line between the first confectionery material and the second confectionery material.

6. The apparatus of claim 4 wherein the continuous confectionery product has a blend area between the first confectionery material and the second confectionery material.

7. The apparatus of claim 3 further comprising a conveyor proximate to the dispensing member for receiving an amount of a dispensed fluid confectionery material, the conveyor in operative communication with the rotary valve.

8. The apparatus of claim 7 wherein the movement of the conveyor is coordinated with the rotation of the rotary valve.

9. The apparatus of claim 1 wherein the first and second bores are disposed in a vertically stacked arrangement in the rotary valve.

10. The apparatus of claim 1 wherein the first bore and the second bore each extend diametrically through the rotary valve.

11. A method for depositing a multiple phase confectionery article comprising:
providing a depositing apparatus having a housing and a rotary valve disposed within the housing, the housing having a first inlet and outlet arrangement and a second inlet and outlet arrangement, the inlets in fluid communication with respective first and second sources of fluid confectionery material, the outlets in fluid communication with a dispensing member;
moving the rotary valve to a first position to dispense the first fluid confectionery from the dispensing member;
further moving the rotary valve to a second position to dispense the second fluid confectionery from the dispensing member; and
forming a continuous confectionery product having amounts of the first and second confectionery material.

12. The method of claim 11 wherein the rotary valve includes a first bore extending therethrough and the moving further comprises providing fluid communication between the first inlet and the first outlet with the first bore.

13. The method of claim 11 wherein the rotary valve includes a second bore extending therethrough and the further moving further comprises providing fluid communication between the second inlet and the second outlet with the second bore.

14. The method of claim 11 further comprising rapidly further moving the rotary valve to form a delineation line between the first and the second confectionery material in the confectionery product.

15. The method of claim 11 further comprising slowly further moving the rotary valve to form a blend area between the first and second confectionery material in the confectionery product.

16. The method of claim 11 further comprising receiving the confectionery product on a conveyor.

17. The method of claim 16 further comprising coordinating the moving and the further moving with the receiving.

18. A method for depositing a multiple phase confectionery article comprising:
providing a depositing apparatus having a housing and a rotary valve disposed within the housing, the housing having a plurality of inlet and outlet arrangements, each inlet in fluid communication with a respective source of fluid confectionery material, each outlet in fluid communication with a dispensing member;
sequentially moving the rotary valve to dispense an amount of each of the plurality of confectionery materials from each respective inlet and outlet arrangement through the dispensing member; and
forming a continuous confectionery product having a sequence of each confectionery material.

19. The method of claim 18 finther comprising repeating the sequentially moving and forming a continuous confectionery product having a repeating sequence of each confectionery material.

20. The method of claim 18 wherein the sequentially moving further comprises moving the rotary valve between a first position, a second position, a third position, and a fourth position in a predetermined order.

21. A confectionery article comprising:
a confectionery product having a width and a thickness, the confectionery product comprising at least two confectionery materials, each confectionery material extending across the width and through the thickness of the confectionery product, each confectionery material having a visually different property.

22. The confectionery article of claim 21 wherein the at least two confectionery materials further comprises from about 3 to about 10 confectionery materials.

23. The confectionery article of claim 21 wherein the at least two confectionery materials having a visually different property form a visual unit, the confectionery product further comprising a repeating sequence of two visual units to about 50 visual units.

24. The confectionery article of claim 21 wherein the visually different property is selected from the group consisting of color, surface texture, confectionery composition and combinations thereof.

25. The confectionery article of claim 21 wherein each of the at least two confectionery materials has a different organoleptic property selected from the group consisting of flavor, aroma, softness, mouthfeel, and combinations thereof.

26. The confectionery article of claim 21 wherein the at least two confectionery materials are selected from the group consisting of coextruded confectionery materials and sequentially dispensed confectionery materials.

27. The confectionery article of claim 21 wherein the confectionery material is selected from the group consisting of chewing gum, bubble gum, nougat, pliable confectionery material, taffy, chewy candy, caramel, and combinations thereof.

28. The confectionery article of claim 21 wherein the product has a thickness from about 0.03 inches to about 2.0 inches and a length from about 1 foot to about 15 feet.

29. The confectionery article of claim 21 wherein each confectionery material has a length from about 1 inch to about one foot.

30. The confectionery article of claim 21 wherein each confectionery material has a width from about 0.25 inches to about 12 inches.

31. The confectionery article of claim 21 wherein each of the at least two confectionery materials is visible from the top, bottom, and sides of the confectionery product.

32. The confectionery article of claim 21 further comprising four confectionery materials, each confectionery material having a different color.

33. The confectionery article of claim 32 wherein each of the four confectionery materials has a respective different flavor.

34. The confectionery article of claim 32 wherein the length of the confectionery product is from about 6 feet to about 15 feet and the length of each confectionery material is from about one inch to about one foot.

35. The confectionery article of claim 21 further comprising a delineation line between each confectionery material.

36. The confectionery article of claim 21 further comprising a blend area between each confectionery material.
